(19) United States
(12) Patent Application Publication
(10) Pub. No.: US 2008/0314221 A1
(43) Pub. Date: Dec. 25, 2008

(54) Blade Holder Having Integrated Bearing Means For The Blade Support

(76) Inventor: Rudolfe Supe-Dienes, Overath (DE)

Correspondence Address: ROBERT W. BECKER & ASSOCIATES, 707 HIGHWAY 333, SUITE B, TIJERAS, NM, 87059-7507, US

(21) Appl. No.: 12/143,984

(22) Filed: Jun. 23, 2008

(30) Foreign Application Priority Data
Jun. 22, 2007 (DE) 20 2007 008 780.2

(51) Int. Cl. B26D 7/26

(52) U.S. Cl. 83/698.51

(57) ABSTRACT

A blade holder for a slitting machine, comprising a blade head supported on a raising and lowering mechanism, a circular blade supported on the blade head and movable via an adjusting mechanism on the blade head between a cutting position and a rest position, a blade support disposed on the blade head and provided for supporting the circular blade, and a base portion, wherein the blade support is located on the base portion, and the blade support and the base portion are directly embodied as an outer race and an inner race of a bearing provided for support of the blade support on the base portion.

### BACKGROUND OF THE INVENTION

The present invention relates to a blade holder for slitting machines, and has a blade head that is supported on a raising and lowering mechanism, and a circular blade supported thereon, whereby the blade head, which is provided with an adjusting mechanism for the circular blade, which is movable between a cutting position and a rest position, has a blade support disposed thereon for the circular blade, with the blade support being located on a base portion.

A blade holder having the aforementioned features is know, for example, from DE 41 14 059 A1. For the rotational mounting of the circular blade on the blade head, a base portion is seated on a bearing disposed in the extension of the adjusting piston rod of the adjustment mechanism; the bearing can, for example, be embodied as a roller bearing. The base portion in turn supports a blade support seated thereon for the circular blade that is secured to the blade support.

A blade head having such a configuration has the drawback that a complete roller bearing, as a structural component, has to be integrated into the construction of the blade head, as a result of which the overall size of the blade head is correspondingly increased. In addition, the inwardly disposed roller bearing, due to the components seated outwardly thereon, is subject to relatively large centrifugal forces.

It is therefore an object of the present invention to reduce the overall size of a blade head, as a component of a blade holder of the aforementioned general type, and to simplify its construction.

### BRIEF DESCRIPTION OF THE DRAWING

This object, and other object and advantages of the present invention, will appear more clearly from the following specification in conjunction with the accompanying schematic drawing, in which:

FIG. 1 is a side view of a blade holder, and

FIG. 2 is a cross-sectional view through the blade head of a blade holder according to FIG. 1.

### SUMMARY OF THE INVENTION

The basic concept of the present invention is that the blade support and the base portion are directly embodied as an outer race and an inner race of a bearing that is provided for the support of the blade support on the base portion.

The blade holder of the present invention has the advantage that the bearing is integrated into the construction of the blade head, thus eliminating the need for a separate inner race as well as a separate outer race as components of a conventional bearing. This reduces the space required for the arrangement of a bearing; at the same time, the blade head has a lower weight.

Pursuant to a first embodiment of the invention, the bearing can be embodied as a roller bearing having roller bodies that are disposed between the inner peripheral surface of the blade support as the outer race, and the outer peripheral surface of the base portion as the inner race. In this connection, pursuant to one embodiment of the invention the roller bearing can be embodied as a ball bearing; other roller body forms can also be utilized within the scope of the present invention.

Pursuant to an alternative embodiment of the invention, the bearing can be embodied as a sliding, sleeve, or friction bearing having the inner peripheral surface of the blade support as the outer race, and the outer peripheral surface of the base portion as the inner race, slide on one another, or the bearing can be embodied as a hydrostatic bearing having the inner peripheral surface of the blade support as the outer race, and the outer peripheral surface of the base portion as the inner race, glide on one another, as well as having a glide film disposed between them, whereby the glide film can be oil that is pressed or pumped into the hydrostatic bearing.

Pursuant to another body on the present invention, the base portion can be connected with an adjusting piston rod as part of the adjusting mechanism.

Pursuant to a particularly expedient embodiment of the present invention, the base portion is a monolithic component of an adjusting piston rod as part of the adjusting mechanism, whereby in so doing the number of components that have to be used is advantageously reduced even further.

Further specific features of the present application will be described in detail subsequently.

### Description of Specific Embodiments

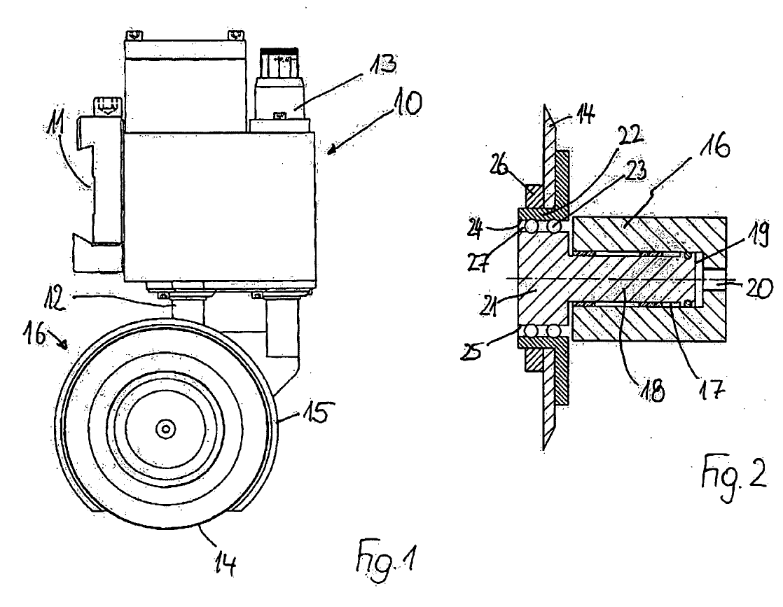

Referring now to the drawing in detail, the blade holder 10 shown in FIG. 1 is adapted to be placed on a crosspiece of a slitting machine, not illustrated in further detail, by means of a clamping mechanism 11. The blade holder 10 is furthermore adapted to be displaced in a suitable manner along the crosspiece, and finally to be secured in position thereon in a prescribed cutting position. The blade holder 10 is provided with a raising and lowering mechanism 12, which is not illustrated in detail, for the blade head 16 supported thereby, and is also provided with a depth adjusting means 13 for adjusting the lowering displacement of the raising and lowering mechanism 12.

As can furthermore be seen from FIG. 1, disposed on the blade head 16 is a circular blade 14, which is surrounded by a hand guard 15. To this extent, the blade holder illustrated in FIG. 1 corresponds to the state of the art.

As can be seen from the schematic illustration of the blade head 16 in FIG. 2, the blade head 16 is provided with a bore 17 in which an adjusting piston rod 18 having a piston surface 19 disposed at an end face thereof is movable; associated with the piston surface 19 in the blade head 16 is an opening as an air inlet 20, so that in a known manner the bore 17 in the blade head 16 can be supplied with compressed air, which leads to a telescoping movement of the adjusting piston rod 18 out of the blade head 16 and hence to a movement of the circular blade 14 into its cutting position. Although not further illustrated, the return of the circular blade 14 can be effected via a return spring disposed in the region of the blade head, as this is fundamentally we also described in the state of the art.

With the illustrated embodiment, monolithically connected with the adjusting piston rod 18 is a base portion 21 on which a blade support 22 is rotatably disposed. The circular blade 14 is located or seated on the blade support 22, and is secured in position on it by means of, for example, a retention or securement nut 26 that is threaded onto the blade support 22.

An intermediate space 27 is left between the inner peripheral surface 24 of the blade support 22 and the outer peripheral surface 25 of the base portion 21; disposed in this intermediate space 27 are roller bodies 23, preferably in the form of balls. Thus, the blade support 22 and the base portion 21, in conjunction with one another, form a roller bearing that is in the form of a ball bearing and is integrated into the construction of the blade head 16.

The features of the subject matter disclosed in the preceding specification, the patent claims and the drawing can be important individually as well as in any combination with one another for realizing the various embodiments of the invention.

The specification incorporates by reference the disclosure of German priority document DE 20 2007 008 780.2 filed 22 Jun. 2007.

The present invention is, of course, in no way restricted to the specific disclosure of the specification and drawing, but also encompasses any modifications within the scope of the appended claims.

What I claim is:

1. A blade holder for a slitting machine, comprising:
a blade head adapted to be supported on a raising and lowering mechanism;
a circular blade supported on said blade head and movable between a cutting position and a rest position;
an adjusting mechanism provided on said blade head for effecting movement of said circular blade between the cutting and rest positions thereof;
a blade support disposed on said blade head and provided for supporting said circular blade; and
a base portion, wherein said blade support is located on said base portion, and wherein said blade support and said base portion are directly embodied as an outer race and an inner race of a bearing provided for support of said blade support on said base portion.

2. A blade holder according to claim 1, wherein said bearing is embodied as a roller bearing having roller bodies disposed between an inner peripheral surface of said blade support as the outer race, and an outer peripheral surface of said base portion as the inner race.

3. A blade holder according to claim 2, wherein said roller bearing is embodied as a ball bearing.

4. A blade holder according to claim 1, wherein said bearing is embodied as a friction bearing having an inner peripheral surface of said blade support as the outer race, and an outer peripheral surface of said base portion as the inner race, slide upon one another.

5. A blade holder according to claim 1, wherein said bearing is embodied as a hydrostatic bearing having an inner peripheral surface of said blade support as the outer race, and an outer peripheral surface of said base portion as the inner race, glide upon one another, and wherein a glide film is disposed between the inner peripheral surface of said blade support and the outer peripheral surface of said base portion.

6. A blade holder according to claim 5, wherein said glide film is comprised of oil pressed into said hydrostatic bearing.

7. A blade holder according to claim 1, wherein said adjusting mechanism includes an adjusting piston rod, and wherein said base portion is connected to said adjusting piston rod.

8. A blade holder according to claim 1, wherein said adjusting mechanism includes an adjusting piston rod, and wherein said base portion is monolithic with said adjusting piston rod.
